(19) United States
(12) Patent Application Publication
(10) Pub. No.: US 2007/0256711 A1
(43) Pub. Date: Nov. 8, 2007

(54) SUBSTRATE CLEANING APPARATUS AND METHOD

(76) Inventors: Toshihide HAYASHI, Yokohama-shi (JP); Tsutomu Makino, Yokohama-shi (JP); Takahiko Wakatsuki, Yokohama-shi (JP); Naoya Hayamizu, Yokohama-shi (JP); Hiroshi Fujita, Yokohama-shi (JP); Akiko Saito, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/683,582

(22) Filed: Mar. 8, 2007

(30) Foreign Application Priority Data
Mar. 10, 2006 (JP) 2006-066257

(51) Int. Cl. B08B 3/00

(52) U.S. Cl. 134/26; 134/94.1

(57) ABSTRACT

A cleaning apparatus to remove organic substances deposited onto a substrate, the apparatus includes a transport unit configured to transport the substrate, a water steam ejection unit configured to eject a heated water steam to a face of the substrate to be transported deposited with the organic substances, and a physical force applying unit configured to apply a physical force to the organic substances deposited onto the substrate to be transported.

### CROSS-REFERENCE TO RELATED APPLICATIONS

This application is based upon and claims the benefit of priority from prior Japanese Patent Application No. 2006-066257, filed Mar. 10, 2006, the entire contents of which are incorporated herein by reference.

### BACKGROUND OF THE INVENTION

1. Field of the Invention

The present invention relates to a substrate cleaning apparatus and a substrate cleaning method for removing an organic material deposited onto a surface of a substrate.

2. Description of the Related Art

In the case of manufacturing a liquid crystal display device, for example, a lithography process is employed for forming a circuit pattern on a glass-based substrate. In this lithography process, as is well known, a resist film for carrying out etching is applied or a polyimide film is coated to form a protective film or an inter-layered insulation film.

When a predetermined circuit pattern has been formed on the substrate described above, cleaning treatment is carried out for removing unnecessary resist and polyimide films that remain on the substrate. In the case of cleaning organic substances such as the unnecessary resist and polyimide films that remain on the substrate, a chemical has been conventionally used. For example, in the case of the resist film, an amine-based releasing liquid is employed, and in the case of the polyimide film, an NMP (N-methyl-2-pyrolidone) is employed.

Recently, with the use of a large-sized substrate, a film or alignment paper has been pasted and packaged in order to protect a substrate before treated. Therefore, various organic substances associated therewith may be deposited onto a substrate surface before treated. In such a case, cleaning using an alkaline cleaning agent is carried out in order to remove such organic substances.

The related art of cleaning substrates by employing chemicals is disclosed in Jpn. Pat. Appln. KOKAI Publication No. 2005-32819.

However, in the case where the organic substances deposited onto the substrate is removed by employing the chemical, the amine-based stripping liquid, NMP, or alkaline-based cleaning agent described above is expensive, thus resulting in higher costs required for cleaning substrates.

Further, if the chemical after use is discarded without being treated, it causes incidences of pollution. Thus, various inconveniences occur with such waste management. Furthermore, in order to remove organic substances by means of chemicals, the organic substances are decomposed and removed by means of chemical reaction using chemicals. Thus, it takes long until the organic substances are decomposed and a takt time required for treatment has been extended.

An object of the present invention is to provide a substrate cleaning apparatus and a substrate cleaning method capable of cleaning and removing the organic substances deposited onto the substrate.

### BRIEF SUMMARY OF THE INVENTION

According to an aspect of the present invention, there is provided a cleaning apparatus to remove organic substances deposited onto a substrate, the apparatus including: a transport unit configured to transport the substrate; a water steam ejection unit configured to eject a heated water steam to a face of the substrate to be transported deposited with the organic substances; and a physical force applying unit configured to apply a physical force to the organic substances deposited onto the substrate to be transported.

According to another aspect of the present invention, there is provided a cleaning method of removing organic substances deposited onto a substrate, the method including: transporting the substrate; ejecting a heated water steam to a face of the substrate to be transported deposited with the organic substances; and applying a physical force to the organic substances deposited onto the substrate to be transported.

### BRIEF DESCRIPTION OF THE SEVERAL VIEWS OF THE DRAWING

The accompanying drawings, which are incorporated in and constitute a part of the specification, illustrate embodiments of the invention.

FIG. 1 is a schematic block diagram depicting a cleaning apparatus according to a first embodiment of the present invention;

FIG. 2 is a schematic block diagram depicting a cleaning apparatus according to a second embodiment of the present invention as a modified example of the cleaning apparatus shown in FIG. 1;

FIG. 3 is a schematic block diagram depicting a cleaning apparatus according to a third embodiment of the present invention;

FIG. 4 is a schematic block diagram depicting a cleaning apparatus according to a fourth embodiment of the present invention as a modified example of the cleaning apparatus shown in FIG. 3;

FIG. 5 is a schematic block diagram depicting a cleaning apparatus according to a fifth embodiment of the present invention;

FIG. 6 is a schematic block diagram depicting a cleaning apparatus according to a sixth embodiment of the present invention as a modified example of the cleaning apparatus shown in FIG. 5;

FIG. 7 is a schematic block diagram depicting a cleaning apparatus according to a seventh embodiment of the present invention; and

FIG. 8 is a schematic block diagram depicting a cleaning apparatus according to an eighth embodiment of the present invention as a modified example of the cleaning apparatus shown in FIG. 7.

### DETAILED DESCRIPTION OF THE INVENTION

Hereinafter, embodiments of the present invention will be described with reference to the accompanying drawings.

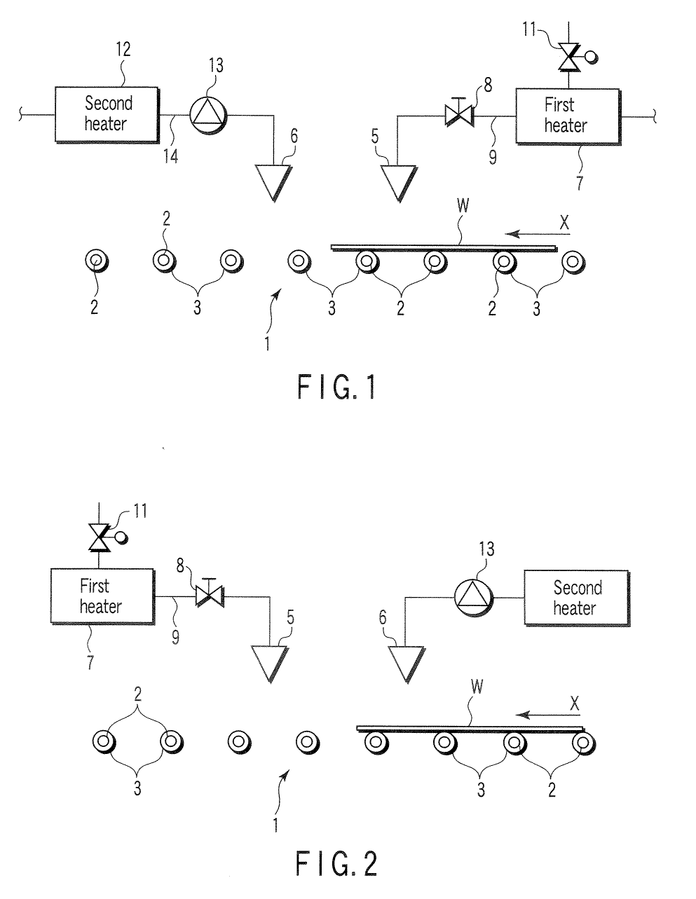

FIG. 1 shows a substrate cleaning apparatus according to a first embodiment of the present invention. This cleaning apparatus is equipped with transporter 1 for transporting a substrate W in the X direction indicated by the arrow in a horizontal state. This transporter 1 has a plurality of transport shafts 2 disposed at the same level while axes thereof are made parallel to one another. At each of the transport shafts 2, a plurality of transport rollers 3 are provided with predetermined gaps.

The transport shafts 2 described above are rotationally driven by means of a drive source not shown. In this manner, the substrate W described above is transported in the direction indicated by the arrow X in the figure by means of the transport rollers 3 described above while a substrate face, on which the organic substances to be cleaned and removed have been deposited like a film, is upwardly oriented.

Upwardly of the substrate W to be transported, a water steam ejection nozzle 5 serving to eject water steam and a shower nozzle 6 serving to apply a physical force are sequentially disposed along the transport direction of the substrate W described above.

The water steam ejection nozzle 5 disposed at the upstream side in the transport direction of the substrate W has a first heater 7 for heating a cleaning liquid such as pure water or tap water to generate water steam. The water steam produced by means of this first heater 7 is supplied to the water steam ejection nozzle 5 through a steam supply pipe 9 having a opening/closing valve 8. Then, the water steam supplied to the water steam ejection nozzle 5 is ejected toward a top face of the substrate W on which the film-like organic substances have been deposited, the substrate being transported in the direction indicated by the arrow X.

A temperature of the water steam generated by means of the first heater 7 and supplied to the steam supply pipe 9 is equal to or higher than 100° C., for example, 140° C.; and the resultant pressure may be equal to or higher than an atmospheric pressure. In the present embodiment, the pressure is set at the atmospheric pressure.

The temperature of the water steam can be set by controlling power supply to a heater (not shown) provided at the first heater 7, and the pressure can be set by adjusting a pressure adjustment valve 11 provided at the first heater 7.

A water supply pipe 14 having a second heater 12 and a pressurization pimp 13 is connected to the shower nozzle 6 described above. A cleaning liquid such as pure water or tap water is supplied to the water supply pipe 14. The cleaning liquid supplied to the water supply pipe 14 is heated to 60° C. or more by means of the second heater 12 described above, and the pressure is applied by means of the pressurization pump 13 described above so as to be equal to or higher than a pressure of 1 MPa.

In the present embodiment, the second heater 12 is designed to heat the cleaning liquid to 70° C., and the pressurization pump 13 is designed to pressurize the heated cleaning liquid to a pressure of 5 MPa, and then, supply the pressurized cleaning liquid to the shower nozzle 6.

In the thus configured cleaning apparatus, when the substrate W of which organic substances are deposited on a top face is transported in the direction indicated by the arrow X by means of the transport rollers 3, and then, reaches below the water steam ejection nozzle 5, the water steam heated to 140° C. is ejected and supplied onto the top face of the substrate W at an atmospheric pressure over a full length in a widthwise direction.

The water steam supplied onto the top face of the substrate W permeates the film-like organic substances deposited onto the top face of the substrate, and then, reaches an interface between the face of the substrate W and the organic substances. In this manner, intimacy of the organic substances with respect to the face of the substrate W is reduced, and the organic substances are stripped from the face of the substrate W. Further, since the temperature of water steam is as high as 140° C., hydrolysis or thermal decomposition of the organic substances is accelerated.

The substance W having passed below the water steam ejection nozzle 5 is transported to below the shower nozzle 6. In the shower nozzle 6, the cleaning liquid heated to 70° C. is supplied to the substrate W over a full length in the widthwise direction of the substrate at a high pressure of 5 MPa.

On the substrate W transported to below the shower nozzle 6, the organic substances are stripped from the substrate face by means of the water steam ejected from the water steam ejection nozzle 5 at the upstream side of the shower nozzle 6, and moreover, decomposition is accelerated. Namely, the organic substances on the substrate W has become brittle.

Therefore, the brittle organic substances on the face of the substrate W are removed while being crushed by means of the pressure of the cleaning liquid ejected from the shower nozzle 6 to the substrate W, and further, the top face of the substrate W is clearly cleaned by means of the heated/pressurized cleaning liquid. In other words, the cleaning liquid is heated to 70° C., and is pressurized to 5 MPa. Thus, even if microscopic organic substances are deposited and left on the face of the substrate W, such organic substances are also clearly cleaned and removed.

In this way, hot water steam is supplied onto the face of the substrate W on which organic substances have been deposited, and then, the heated/pressurized cleaning liquid is ejected to impart a physical force. Thus, the organic substances described above can be removed from the face of the substrate W without employing chemicals.

Moreover, the intimacy of the organic substances with respect to the face of the substrate W is reduced by means of the hot water steam, and then, the highly pressurized cleaning liquid is ejected to impart a physical force. Thus, in comparison with a case of removing organic substances in chemical reaction by means of chemicals, it becomes possible to remove the organic substances efficiently and speedily. In other words, a takt time required for treatment can be reduced.

FIG. 2 shows a second embodiment of the present invention as a modified example of the first embodiment shown in FIG. 1. In the second embodiment, a shower nozzle 6 serving to apply a physical force is disposed at the upstream side in the transport direction of the substrate W, and a water steam ejection nozzle 5 is disposed at the downstream side.

If the dispositions of the shower nozzle 6 and the water steam ejection nozzle 5 are reversed, the organic substances deposited onto the substrate W are first subjected to a physical force from a highly pressurized cleaning liquid ejected from the shower nozzle 6, whereby defects are formed on films of the organic substances. In other words, a number of scratches are formed thereon.

Then, hot water steam is ejected by means of the water steam ejection nozzle 5 onto the substrate W of which a number of scratches have been formed on the films of the organic substances. Since the organic substances of the substrate W are scratched, a square area of contact with water steam increases. Thus, water steam easily permeates the films of the organic substances.

Therefore, the organic substances are stripped and removed from the face of the substrate W by means of the water steam. In this case, by setting the pressure of the water steam to be higher than an atmospheric pressure, the organic substances can be stripped and removed more efficiently from the face of the substrate W.

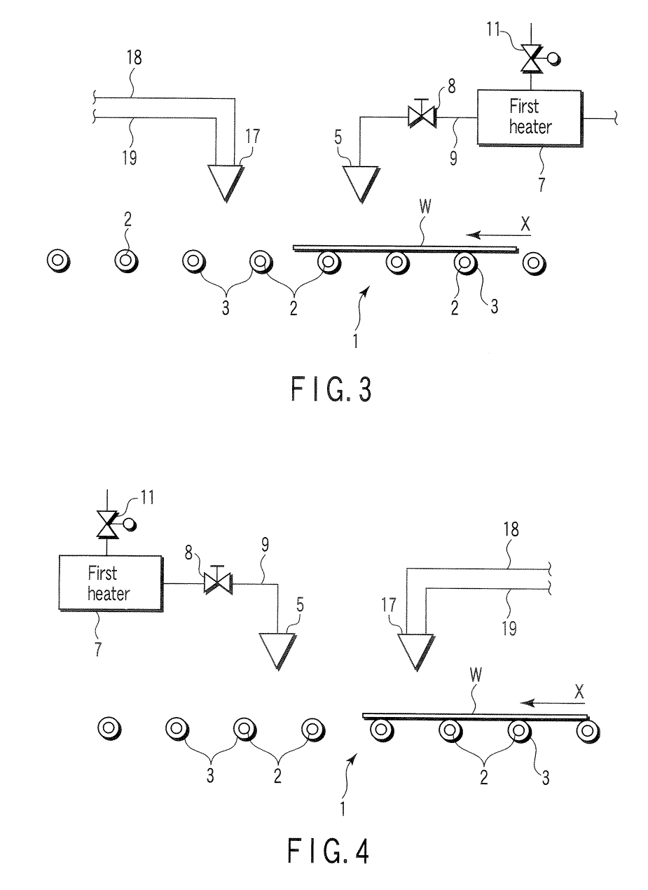

FIG. 3 shows a third embodiment of the present invention. In the third embodiment, at the downstream side of a water steam ejection nozzle 5, a two-fluid nozzle 17 serving to apply a physical force is disposed. A cleaning liquid heated to equal to or greater than 60° C., for example, to 70° C. by means of a water supply pipe 18 is supplied to the two-fluid nozzle 17 and compressed air pressurized to a predetermined pressure, for example, to 0.2 MPa is also supplied thereto through an air supply pipe 19. Then, the cleaning liquid supplied to the two-fluid nozzle 17 is pressurized by means of the compressed air, whereby the resulting mist-like cleaning liquid is ejected toward the substrate W.

The pressurized, heated mist-like cleaning liquid to be ejected from the two-fluid nozzle 17 applies a physical force to the face of the substrate W. In this manner, the organic substances, whose intimacy with respect to the face of the substrate W has been weakened by means of the water steam ejection nozzle 5 disposed at the upstream side, are crushed by means of a pressure of the mist-like fluid ejected from the two-fluid nozzle 17, and then, are cleaned and removed from the face of the substrate W.

In other words, in the third embodiment as well, the organic substances deposited onto the face of the substrate W can be removed reliably and speedily by means of water steam and a physical force.

Table 1 shown below gives an example in which a cleaning effect has been measured at the time of changing a temperature of a cleaning liquid supplied to the two-fluid nozzle 17. The cleaning effect denotes a ratio of a square area having organic substances stripped therefrom, to a square area supplied with the cleaning liquid of the substrate W.

The cleaning conditions of the substrate W are that a transport speed of the substrate W is 300 mm/min; a steam setting temperature is 180° C.; and an ejection pressure of the cleaning liquid from the two-fluid nozzle 17 is 0.4 MPa.

TABLE 1

| Temperature of | Area in which organic |
|---|---|
| cleaning liquid | substrates have |
| (° C.) | been stripped (%) |
| 25 | 40 |
| 40 | 50 |
| 60 | 80 |
| 70 | 80 |
| 80 | 90 |
| 90 | 100 |
| 98 | 100 |

As is evident from Table 1 above, it was verified that, when the temperature of the cleaning liquid is equal to or higher than 60° C., a square area of releasing organic substances from the face of the substrate W rapidly increases. In other words, while the square area of releasing organic substances was 50% when the temperature of the cleaning liquid was 40° C., the area was improved to 80% by setting the temperature at 60° C. From this fact, it was successfully verified that the cleaning effect is improved by setting the temperature of the cleaning liquid to be equal to or higher than 60° C.

FIG. 4 shows a fourth embodiment of the present invention as a modified example of the third embodiment. In the present embodiment, a two-fluid nozzle 17 serving to apply a physical force is disposed at the upstream side in the transport direction of a substrate W, and a water steam ejection nozzle 5 is disposed at the downstream side.

When the dispositions of the two-fluid nozzle 17 and the water steam ejection nozzle 5 are reversed from the state of the third embodiment, the organic substances deposited onto the substrate W are first subjected to a physical force from a highly pressurized cleaning liquid ejected from the two-fluid nozzle 17, whereby defects are formed on films of the organic substances. In other words, a number of scratches are formed thereon.

In a state in which a number of scratches are formed on organic films, the substrate W is transported to below the water steam ejection nozzle 5, and then, water steam is ejected from the water steam ejection nozzle 5 to the substrate W. The organic substances deposited onto the substrate W are scratched by means of the physical force applied from the two-fluid nozzle 17. Thus, a square area of contact between the organic substances and water steam increases, and then, the water steam easily permeates the organic substances.

Therefore, the organic substances are stripped and removed from the face of the substrate W by means of the water steam. At this time, by setting a pressure of the water steam to be higher than an atmospheric pressure, the organic substances are efficiently stripped from the face of the substrate W, and further, the stripped organic substances are easily removed from the face of the substrate W.

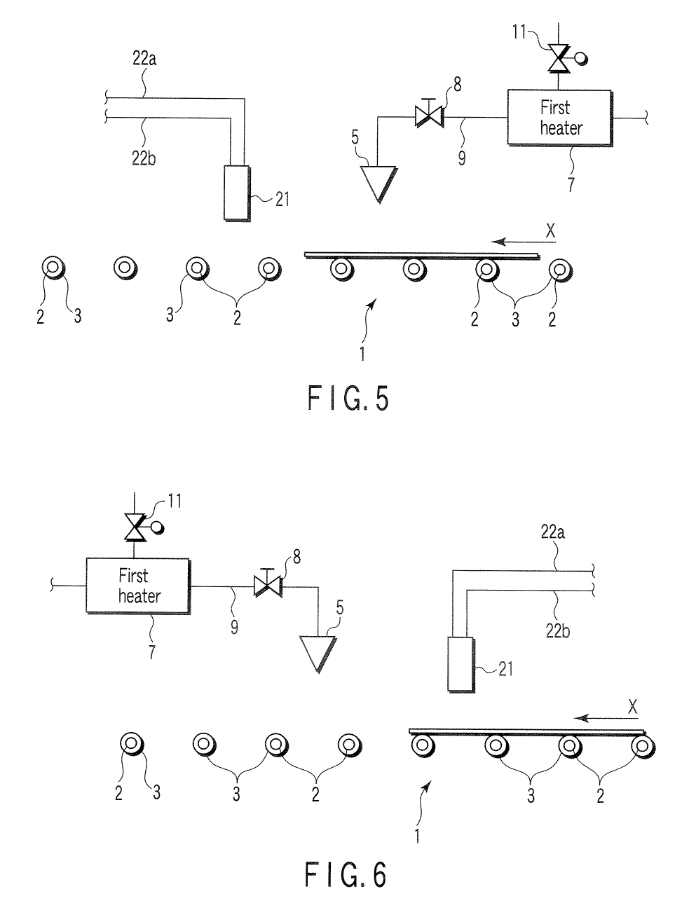

FIG. 5 shows a fifth embodiment of the present invention. In the present embodiment, a water steam ejection nozzle 5 is disposed at the upstream side in the transport direction of a substrate W, and a high pressure fluid ejection unit 21 serving to apply a physical force is disposed at the downstream side. In the present embodiment, the high pressure fluid ejection unit 21 carries out ejection by pressurizing a cleaning liquid heated to 60° C. or more, for example 70° C. in the present embodiment, up to a high pressure equal to or higher than 1 MPa, for example, up to 5 MPa.

In other words, the cleaning liquid heated to 70° C. is supplied to the high pressure fluid ejection unit 21 by means of a liquid supply pipe 22a and the gas pressurized to 5 MPa is also supplied thereto by means of a air supply pipe 22b. In this manner, the cleaning liquid containing air bubbles is ejected and supplied at a high pressure from the high pressure fluid ejection unit 21 to the top face of the substrate W.

On the substrate W transported by the transporter 1, intimacy of the organic substances are weakened by means of the water steam ejected from the water steam ejection nozzle 5 positioned at the upstream side in the transport direction. Then, the substrate is subjected to a physical force by means of the cleaning liquid ejected from the high pressure fluid ejection unit 21 and highly pressurized air bubbles contained therein.

In this manner, the organic substances on the face of the substrate W are crushed by means of an impulsive wave received from the air bubbles, and the resulting organic substances are removed from the face of the substrate W. In other words, the organic substances deposited onto the face of the substrate W can be removed reliably and speedily by means of water steam and a physical force.

FIG. 6 shows a sixth embodiment of the present invention as a modified example of the fifth embodiment. In the present embodiment, a high pressure fluid ejection unit 21 serving to apply a physical force is disposed on the upstream side in the transport direction of a substrate W, and a water steam ejection nozzle 5 is disposed at the downstream side. In other words, the dispositions of the above ejection unit and nozzle are reversed from those of the fifth embodiment shown in FIG. 5.

If the dispositions of the high pressure fluid ejection unit 21 and the water steam ejection nozzle 5 are reversed, the organic substances deposited onto the substrate W are first subjected to a physical force from the pressurized/heated cleaning liquid ejected from the high pressure fluid ejection unit 21, whereby defects are formed on films of the organic substances. In other words, a number of scratches are formed thereon.

When the substrate W is transported to below the water steam ejection nozzle 5, and water steam is ejected in a state in which a number of scratches are formed on the organic films, since the organic substances deposited onto the substrate W are scratched, a square area of contact between the organic substances and water steam increases, and thus, the water steam easily permeates the organic substances.

Therefore, the organic substances are stripped and washed out from the face of the substance W by means of the water steam. In this case, by setting a pressure of the water steam to be higher than an atmospheric pressure, the organic substances are stripped efficiently from the face of the substrate W, and further, the stripped organic substances are easily removed from the face of the substrate W.

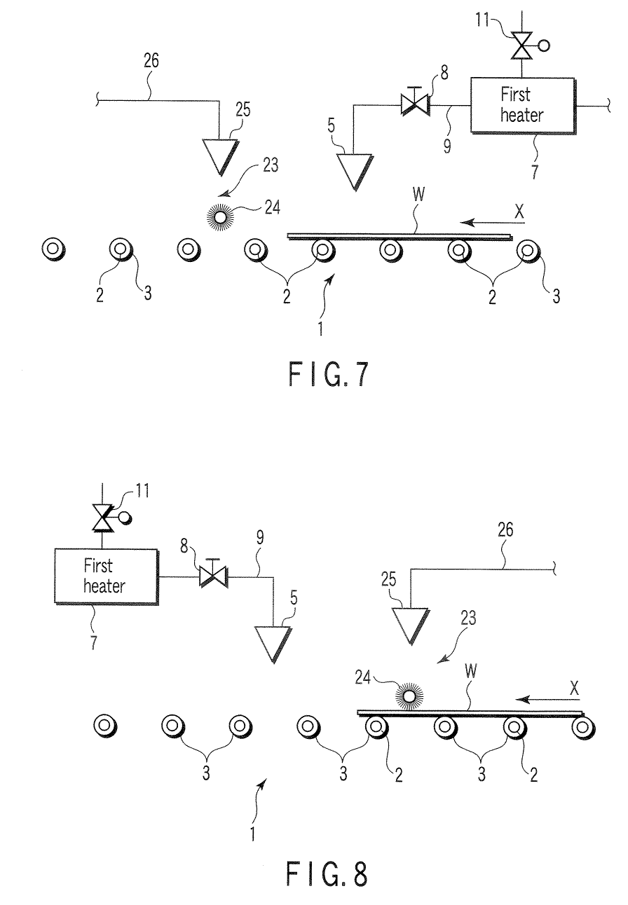

FIG. 7 shows a seventh embodiment of the present invention. In the present embodiment, a water steam ejection nozzle 5 is disposed at the upstream side in the transport direction of a substrate W, and a cleaning brush 23 serving to apply a physical force is disposed at the downstream side. The cleaning brush unit 23 is comprised of: a cleaning brush 24 rotationally driven while resin-based brush bristles are brought into contact with a top face of the substrate W; and a shower nozzle 25 for supplying a cleaning liquid to the cleaning brush 24. A liquid supply pipe 26 is connected to the shower nozzle 25. This liquid supply pipe 26 supplies the cleaning liquid heated to a predetermined temperature, for example, to 70° C. to the cleaning brush 24 through the shower nozzle 25.

With such a configuration, the organic substances whose intimacy has been weakened with respect to the face of the substrate W by means of the water steam ejection nozzle 5 disposed at the upstream side are scrubbed by means of the cleaning brush 24 of the cleaning brush unit 23, and then, are subjected to a physical force. In this manner, the resulting organic substances are stripped from the face of the substrate W and are cleaned and removed by means of the cleaning liquid supplied from the shower nozzle 5. Therefore, the organic substances deposited onto the face of the substrate W can be removed reliably and speedily by means of the water steam and physical force.

FIG. 8 shows an eighth embodiment of the present invention as a modified example of the seventh embodiment. In the present embodiment, a water steam ejection nozzle 5 is disposed at the downstream side in the transport direction of a substrate W, and a cleaning brush unit 23 serving to apply a physical force is disposed at the upstream side.

In this manner, the organic substances deposited onto the substrate W are first scrubbed by means of a cleaning brush 24 of the cleaning brush unit 23, and are subjected to a physical force, whereby a number of scratches are formed on films of the organic substances. When water steam is ejected from the water steam ejection nozzle 5 to the substrate W of which a number of scratches have been formed on an organic film, since the organic substances deposited onto the substrate W are scratched, a square area of contact between the organic substances and the water steam increases, and thus the water steam easily permeates the organic substances. Therefore, the organic substances are stripped and removed from the face of the substrate W by means of water steam.

The present invention is not limited to the embodiments described above. For example, depending on substrates, organic substances are occasionally deposited onto a bottom face as well as a top face. In such a case, the water steam ejection nozzle and the embodiments of the physical force applying unit serving to apply a physical force presented in the first to eighth embodiments described above are disposed to be opposed to a lower face side of a substrate to be transported, whereby the organic substances deposited onto the bottom face can be cleaned and removed in the same manner as those on the top face.

In addition, while it has been demonstrated that a cleaning effect can be attained by heating a cleaning liquid to be equal to or higher than a temperature of 60° C. in accordance with the third embodiment shown in FIG. 3, it is thought that similar advantageous effect can be attained by heating the cleaning liquid to be equal to or higher than 60° C. in other embodiments as well.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cleaning apparatus to remove organic substances deposited onto a substrate, the apparatus comprising:
a transport unit configured to transport the substrate;
a water steam ejection unit configured to eject a heated water steam to a face of the substrate to be transported deposited with the organic substances; and
a physical force applying unit configured to apply a physical force to the organic substances deposited onto the substrate to be transported.

2. The cleaning apparatus according to claim 1, wherein the physical force applying unit comprises a shower nozzle unit configured to eject a pressurized cleaning liquid to a face of the substrate onto which the organic substrates are deposited.

3. The cleaning apparatus according to claim 1, wherein the physical force applying unit comprises a two-fluid nozzle unit configured to mix a cleaning liquid and a gas, and then, to eject the mixture to a face of the substrate onto which the organic substances are deposited.

4. The cleaning apparatus according to claim 1, wherein the physical force applying unit comprises a high pressure fluid ejection unit configured to pressurize a cleaning liquid and to eject the pressurized cleaning liquid to a face of the substrate onto which the organic substances are deposited.

5. The cleaning apparatus according to claim 1, wherein the physical force applying unit comprises a cleaning brush unit configured to carry out brushing and cleaning while supplying a cleaning liquid onto a face of the substrate deposited with the organic substances.

6. A cleaning method of removing organic substances deposited onto a substrate, the method comprising:
transporting the substrate;
ejecting a heated water steam to a face of the substrate to be transported deposited with the organic substances; and
applying a physical force to the organic substances deposited onto the substrate to be transported.

7. The cleaning method according to claim 6, wherein water steam is ejected onto a face of a substrate on which organic substances are deposited, and then, a physical force is applied thereto.

8. The cleaning method according to claim 6, wherein a physical force is applied to a face of a substrate on which organic substances are deposited, and then, water steam is ejected thereto.

9. The cleaning method according to claim 6, wherein the water steam is heated to be equal to or higher than 100° C.
